(19) United States
(12) Patent Application Publication
(10) Pub. No.: US 2008/0073148 A1
(43) Pub. Date: Mar. 27, 2008

(54) HQ Climbing Step

(76) Inventor: Terry Allan Leach, Middleburg, FL (US)

Correspondence Address: WILSON DANIEL SWAYZE, JR., 3804 CLEARWATER CT., PLANO, TX, 75025, US

(21) Appl. No.: 11/535,508

(22) Filed: Sep. 27, 2006

(51) Int. Cl. E06C 9/00

(52) U.S. Cl. 182/92

(57) ABSTRACT

A prefabricated step for insertion in a pair of spaced holes formed in a solid material includes an elongated step member having a harden core, a pair of outwardly projecting support members rigidly attached substantially at right angles thereto, each of the ends of said support members being adapted for insertion into the corresponding holes and having individual substantially arcuate and continuous resilient projections integrally molded thereon, and each of the projections has a slanted face inclined toward the step member and is deformable under pressure.

### BACKGROUND OF THE INVENTION

1. Field of the Invention

The present invention relates to supports and fasteners, especially anchoring devices having deformable projections or threads to fit smaller or tapered openings.

2. Description of the Prior Art

The prior art includes a substantial number of expansion anchors studs, concrete anchoring devices and other similar means providing a rigid device by means of which something may be attached to concrete. However, such devices are generally made from metal or at least a combination of metal and some other material such as rubber, wood or plastic and accordingly require some amount of preparatory work.

U.S. Pat. No. 4,100,997 as shown in FIG. 13 discloses an elongated step member having a pair of outwardly projecting support members integrally molded thereon and rigidly attached substantially at right angles thereto, each of the ends of said support members being tapered for insertion into the corresponding tapered holes and having individual substantially arcuate and continuous resilient projections integrally molded thereon from plastic material and the like. Each of the projections has a slanted face inclined toward the step member and including a marginal edge which is deformable under pressure so that when the end is driven into a respective opening of less distance than the overall distance between the marginal edges of the projections the projections are deformed and the step is held in place. The deformable members are circular and being progressively larger in diameter from the external terminal end toward the step whereby the respective ends may be aligned with a respective spaced hole and driven into a tapered hole to support the step and to seal the respective holes.

### SUMMARY OF THE INVENTION

The present invention relates to an improvement in the plastic coated, steel core reinforced manhole steps in particular, to the drive-in or hammer-in ends of the step construction. These improvements include the dual type wedges which provide greater pullout resistance when inserted into concrete. The inserts of the present invention provides significantly stronger steps and provides less flexible characteristics. Additionally, the present invention provides improvements regarding footing/thread slip resistance and quad reflectors for dark area identification/location.

A carbon/forged steel core is formed of the sort which may be used as part of steps and has plastic, circular threads or projections which may be tapered and deformable so that when inserted in a drilled hole of slightly smaller diameter the projections will be deformed and bend under pressure to retain the fastener in place.

The present concrete anchoring device may be used as step supports of the step and are easily hammered into a tapered opening in a concrete manhole or other concrete structure and will remain that way for a long period of time.

The step has an elongated step member and a pair of projecting support members each being provided with projecting threads which deform when the ends are forced into a opening or an opening of slightly less diameter than the overall diameter of the projections.

Other and further objects and advantages of the present invention will become apparent upon reading the following description of a preferred embodiment taken in conjunction with the accompanying drawings.

### BRIEF DESCRIPTION OF THE DRAWING

The invention may be understood by reference to the following description taken in conjunction with the accompanying drawings, in which, like reference numerals identify like elements, and in which:

FIG. 1 illustrates a top view of the step of the present invention;

FIG. 2 illustrates a first side view of the step of the present invention;

FIG. 3 illustrates a back view of the step of the present invention;

FIG. 4 illustrates a second side view of the step of the present invention;

FIG. 5 illustrates a side view of a first wedge ring of the present invention;

FIG. 6 illustrates a front view of the first wedge ring of the present invention;

FIG. 7 illustrates a back view of the first wedge ring of the present invention;

FIG. 8 illustrates a side view of a second wedge ring of the present invention;

FIG. 9 illustrates a front view of the second wedge ring of the present invention;

FIG. 10 illustrates a back view of the second wedge ring of the present invention;

FIG. 11 illustrates a side view of an end of a step support member;

FIG. 12 illustrates a side view of the end of the step support member in concrete;

FIG. 13 illustrates a perspective view of a step;

### DESCRIPTION

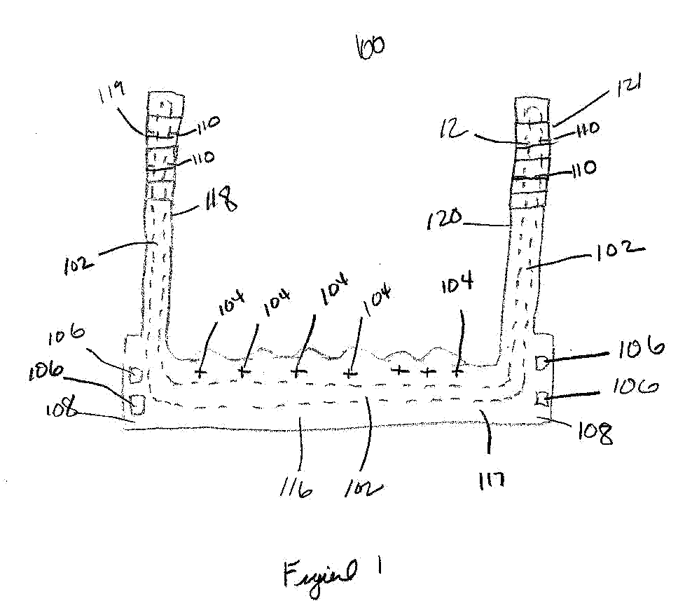

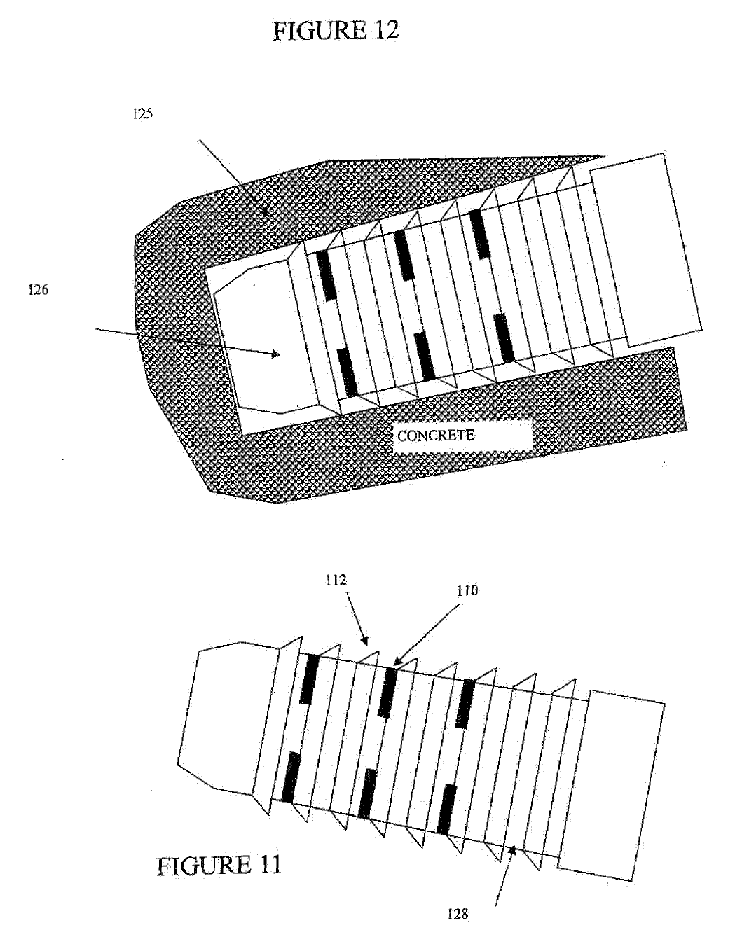

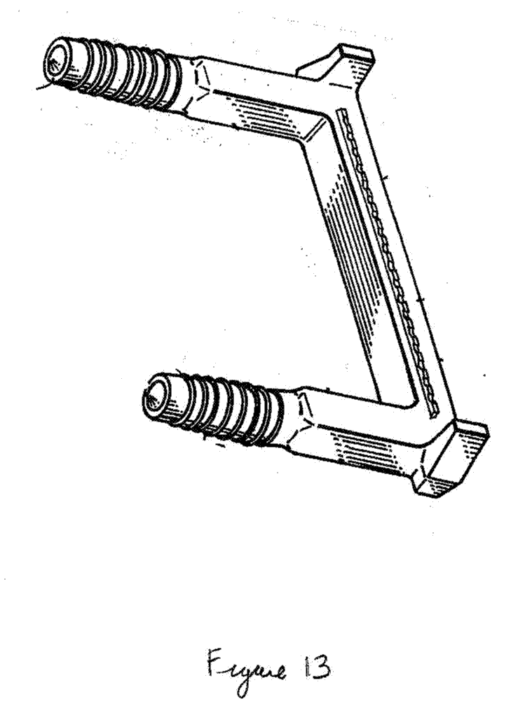

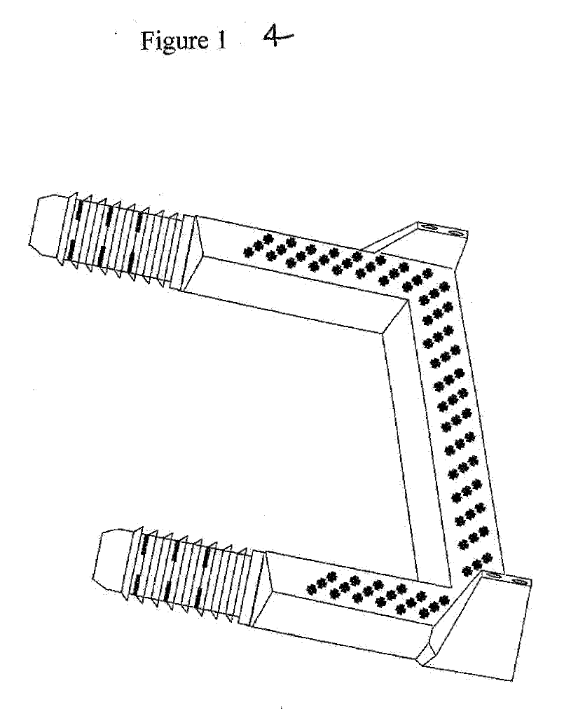

FIG. 1 illustrates a step designated generally by reference numeral 100 and which includes a core 102 which is shown as being substantially U shaped. The core 102 is coated with a plastic material such as polymer, polypropylene or other well known plastic material to protect the core 102 from the elements such as moisture. The core 102 may be formed from carbon/forged steel. The core 102 may be handened by either a cold process or heat treatment. With a cold process, the core 102 could be worked to the desired shape by hammering, pressing, rolling or stretching. With a heat treatment, the properties of the core 102 are changed by a series of temperature changes. The core 102 could be shaped to the round, square, I beam or any other suitable shape. The step 100 includes a step member 116 with an upper flat step surface 117 and respective opposed, step support members 118, 120 extending substantially 90° from the step member 116. The core 102 extends substantially the entire length of the step member 106 and extends substantially the entire length of the step support members 118, 120. Each end 119, 120 of the respective step support members 118, 120 is provided with a particular configuration which constitutes a device for retaining each step support member 118, 120 and the entire step 100 in place in concrete 125 by projections such as the first conical barbed retainer wedge ring 110 and the second conical barb retainer wedge ring 112 in a tapered hole or bore 126 shown in cross-section in FIGS. 11 and 12. The tapered opening or bore 126 is made by a drill or any other suitable means. Each end 119, 121 of the step support members 118, 120 is near identical in construction and is formed to include the plurality of staggered near identical, first conical barb retainer wedge rings 110 and second conical barb retainer wedge rings 120 or other suitable projections which may be the same size or which may be smaller or less in diameter from one another beginning with the endmost one leading toward the step member 116 or substantially the same diameter. Each first conical barb retainer wedge ring 110, 112 may be tapered in a direction towards the distal end of the step support member 118, 120 or not tapered.

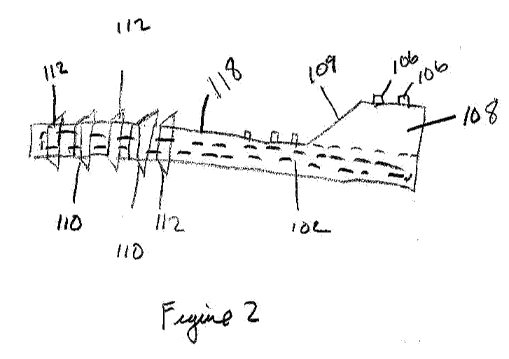

FIG. 2 illustrates a side view of the step support member 118 showing a flair step riser 108 positioned on opposing sides of the step 100 to prevent the shoe of the user of the step 100 from sliding off. The top surface of the flair step riser 108 may include a light reflector 106 to allow identification of the flair step riser 108 under low light conditions. The flair step riser 108 may include a inclined surface 109. FIG. 2 additionally illustrates the core 102 extending along the length of the step support member 118.

FIG. 3 illustrates a back view of the step 100 and shows the core 102 extending along the step member 116. FIG. 3 additionally illustrates the upward projecting protrusions 104 which may be cross (+) shape. These upper projecting protrusions 104 may allow a mating pattern formed on a shoe or boot for increased traction with the shoe or boot and may allow increased traction with a grooved sole.

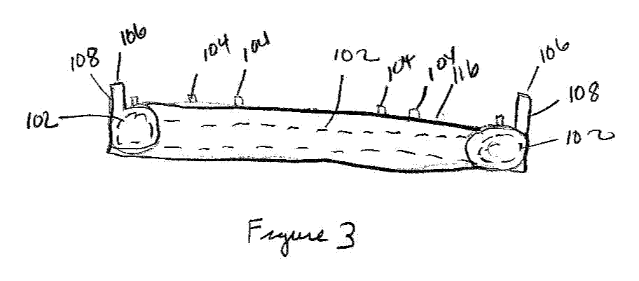

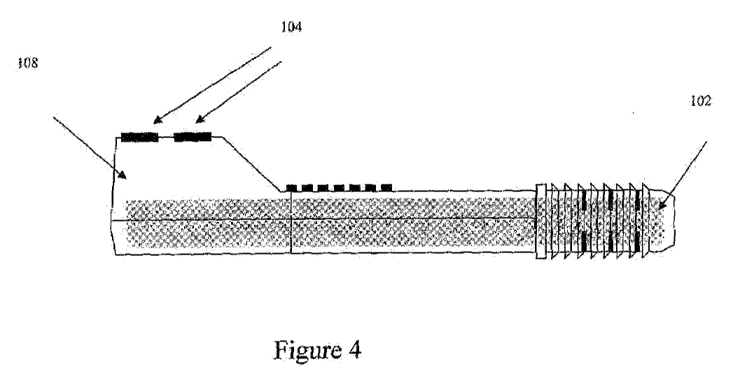

FIG. 4 illustrates the opposing step support member 120 which shows the core 102 extending along the length of the step support member 120.

FIG. 5 illustrates a side view of the first conical barb retainer wedge ring 110 which includes a continuous inclined surface 502 around the periphery of the first comical barb retainer wedge ring 110.

FIG. 6 illustrates a front view of the first conical barb retainer wedge ring 110.

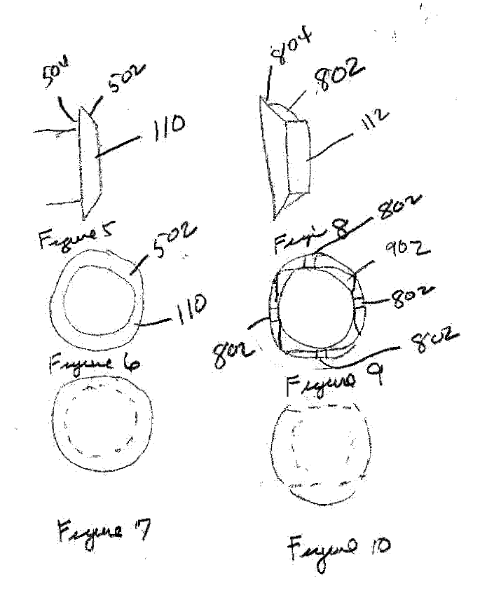

FIG. 7 illustrates a back view of the first comical barb retainer wedge ring 110.

FIG. 8 illustrates a side view of the second conical barb retainer wedge ring 112 which includes a support section 802 which extends from the surface of the step support member 118, 120 to the inclined surface 804 of the second conical barb retainer wedge ring 112. The support section 802 strengthens the second conical barb retainer wedge ring 112. The second conical barb retainer wedge ring 112 is illustrated with a support section 802 spaced equally distant at approximately 90° with respect to another support section 802. Fewer or additional support sections 802 are within the scope of the present invention.

FIG. 9 illustrates that spaced between the support section 808 is discontinuous inclined surface 902.

FIG. 10 illustrates a back view of the second conical barb retainer wedge ring 112.

Accordingly, when the ends 119, 121 are aligned with the respective opening 126 in the concrete 125 and then hammered in place by a mallet or small sledge hammer the retaining wedge rings 110, 112 are caused to deform in the manner shown in FIG. 3 and to be forced under pressure into the opening 26. Thus, the resilient and deformable retaining wedge rings 110, 112 are under pressure holding the ends 119,121 rigidly in place in the respective opening 126.

A plurality of steps 100 are installed one above or below, as the case may be, the other by drilling respective holes 126 to accommodate the ends 119,121 driven into place. Steps 100 may be installed in this manner in a wall or concrete manhole without the use of expansion plugs or anchors.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A prefabricated step for insertion in a pair of spaced holes formed in a solid material, comprising:
an elongated step member having a harden core;
a pair of outwardly projecting support members rigidly attached substantially at right angles thereto, each of the ends of said support members being adapted for insertion into the corresponding holes and having individual substantially arcuate and continuous resilient projections integrally molded thereon and
each of said projections having a slanted face inclined toward the step member and being deformable under pressure.

2. A prefabricated step for insertion in a pair of spaced holes formed in a solid material as in claim 1, wherein said deformable members are substantially circular.

3. A prefabricated step for insertion in a pair of spaced holes formed in a solid material as in claim 1, wherein said core is round shaped.

4. A prefabricated step for insertion in a pair of spaced holes formed in a solid material as in claim 1, wherein said core is square shaped.

5. A prefabricated step for insertion in a pair of spaced holes formed in a solid material as in claim 1, wherein said core is I shaped.

6. A prefabricated step for insertion in a pair of spaced holes formed in a solid material as in claim 1, wherein said projection includes a first wedge ring.

7. A prefabricated step for insertion in a pair of spaced holes formed in a solid material as in claim 6, wherein said protection includes a second wedge ring.

8. A prefabricated step for insertion in a pair of spaced holes formed in a solid material as in claim 7, wherein said first wedge ring and said second wedge ring are staggered.

9. A prefabricated step for insertion in a pair of spaced holes formed in a solid material as in claim 7, wherein said second wedge ring includes a support section.

10. A prefabricated step for insertion in a pair of spaced holes formed in a solid material as in claim 9, wherein said second wedge ring includes a discontinuous section.

11. A prefabricated step for insertion in a pair of spaced holes formed in a solid material as in claim 1, wherein said step includes a flat surface.

12. A prefabricated step for insertion in a pair of spaced holes formed in a solid material as in claim 11, wherein said flat surface includes an upward projecting protrusion.

13. A prefabricated step for insertion in a pair of spaced holes formed in a solid material as in claim 12, wherein said upward projecting protrusion is +shaped.

14. A prefabricated step for insertion in a pair of spaced holes formed in a solid material as in claim 1, wherein said step includes a first flair step riser.

15. A prefabricated step for insertion in a pair of spaced holes formed in a solid material as in claim 14, wherein said first flair step riser includes a first light reflector.

16. A prefabricated step for insertion in a pair of spaced holes formed in a solid material as in claim 14, wherein said step includes a second flair step riser.

17. A prefabricated step for insertion in a pair of spaced holes formed in a solid material as in claim 14, wherein said second flair step riser includes a second light reflector.

18. A prefabricated step for insertion in a pair of spaced holes formed in a solid material as in claim 17, wherein said first light reflector and said second light reflector are positioned on opposing sides of said step.
